(19) United States
(12) Patent Application Publication
(10) Pub. No.: US 2026/0340175 A1
(43) Pub. Date: Oct. 29, 2026

(54) Kernel-Governed Artificial Intelligence Operating System with Non-Delegable Pre-Effect Execution Authority

(71) Applicant: Terence John Chancellor-Maddison, Lakeway, TX (US)

(72) Inventor: Terence John Chancellor-Maddison, Lakeway, TX (US)

(21) Appl. No.: 19/439,399

(22) Filed: Jan. 4, 2026

Related U.S. Application Data
(63) Continuation-in-part of application No. 19/433,103, filed on Dec. 26, 2025.
(60) Provisional application No. 63/930,706, filed on Dec. 4, 2025.
(60) Provisional application No. 63/934,387, filed on Dec. 9, 2025.
(60) Provisional application No. 63/939,171, filed on Dec. 12, 2025.
(60) Provisional application No. 63/952,797, filed on Jan. 2, 2026.

(51) Int. Cl. G06F 21/62

(52) U.S. Cl. CPC G06F 21/6227

(57) ABSTRACT

A kernel-governed artificial intelligence operating system is disclosed that enforces non-delegable pre-effect execution authority over externally effective actions. The system includes a supervisory kernel operating deny-by-default and admitting execution only upon identity-bound, scope-validated authorization. The architecture comprises a dual-tier memory fabric including raw trace memory and curated semantic memory, a dynamic module identity layer, a unified schema governance engine, and a compute routing fabric for model arbitration. Execution proposals generated by subordinate components are evaluated by the kernel prior to tool invocation or external interaction. The system prevents autonomous components from granting execution authority and ensures that no agent, workflow, model, or post-hoc process may authorize execution. The architecture enables controlled cross-domain orchestration while preserving centralized execution control.

### CROSS-REFERENCE TO RELATED APPLICATIONS

This application claims priority to U.S. Non-Provisional application Ser. No. 19/433,103, filed Dec. 26, 2025, and to U.S. Provisional Application No. 63/930,706, filed Dec. 4, 2025, and U.S. Provisional Application No. 63/939,171, filed Dec. 12, 2025, each of which is incorporated by reference for priority purposes only.

### TECHNICAL FIELD

The present disclosure relates to artificial intelligence operating systems, and more particularly to kernel-governed execution control architectures enforcing non-delegable execution authority prior to externally effective action.

### BACKGROUND

Artificial intelligence systems capable of autonomous or semi-autonomous action increasingly perform tasks that produce externally effective actions in software, physical, financial, robotic, and cyber-physical domains. Existing approaches to governing such systems rely on post-hoc monitoring, ethical evaluation, explainability, alignment scoring, policy enforcement, economic constraints, regulatory approval, or human oversight.

These approaches do not constitute execution authority and do not prevent unauthorized execution before external effects occur. As a result, current systems permit action based on inference, probability, optimization, consensus, or narrative justification rather than lawful pre-effect authorization. There exists no operating-system-level mechanism providing a non-delegable execution authority that determines whether execution may occur at all.

### SUMMARY OF THE INVENTION

The present invention is directed to a technological operating system architecture for governing execution within artificial intelligence systems that produce externally effective actions. Unlike systems that merely analyze information, generate recommendations, evaluate ethics, provide explanations, or perform post-hoc monitoring, the disclosed invention controls whether execution occurs at all.

In particular, the invention introduces a Kernel that operates as a mandatory execution-admission authority, enforcing a pre-effect execution boundary such that externally effective actions are permitted only upon contemporaneous admission by the Kernel. The Kernel is distinct from artificial intelligence models, agents, workflows, policy engines, and human operators, and operates independently of model internals, learned representations, confidence measures, or optimization objectives.

The claimed subject matter is not directed to an abstract idea, mental process, or organizational scheme. Rather, it is directed to a concrete improvement in the functioning of artificial intelligence operating environments by preventing unauthorized execution and enforcing failure-closed operation prior to effect. The invention addresses a technical problem unique to artificial intelligence systems capable of autonomous or semi-autonomous action, namely, the absence of a non-delegable, pre-effect execution authority capable of governing real-world effects.

The invention does not rely on ethical reasoning, explainability analysis, alignment scoring, regulatory approval, or human judgment as substitutes for execution authority. Instead, it establishes a technological control mechanism that determines whether execution is admissible before any effect occurs. As such, the invention improves the safety, reliability, and determinism of artificial intelligence systems at the level of execution itself, rather than at the level of analysis, interpretation, or after-the-fact correction.

Accordingly, the claims recite a specific technological solution to a technological problem implemented within an artificial intelligence operating environment and are directed to patent-eligible subject matter under 35 U.S.C. § 101.

### BRIEF DESCRIPTION OF THE DRAWINGS

FIG. 1 illustrates a kernel-governed execution admission flow enforcing non-delegable pre-effect authorization.

FIG. 2 illustrates an aggregated execution boundary in which multiple execution steps are evaluated and admitted or denied as a single indivisible action.

FIG. 3 illustrates a failure-closed denial-without-effect termination model in which absence of kernel admission prevents any externally effective action.

### DETAILED DESCRIPTION OF THE DRAWINGS

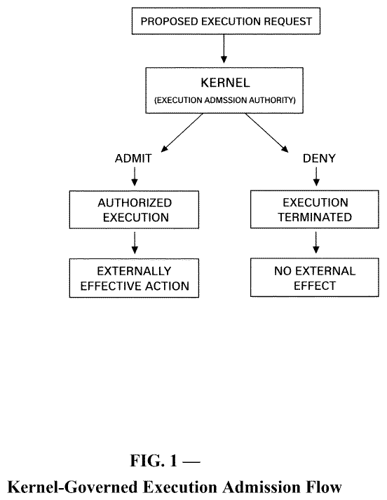

FIG. 1—Kernel-Governed Execution Admission Flow

Referring to FIG. 1, a proposed execution request is transmitted to a Kernel operating as a non-delegable execution-admission authority. The Kernel determines whether execution is admitted or denied prior to any externally effective action.

If the Kernel admits execution, an authorized execution occurs, resulting in an externally effective action. If the Kernel denies execution, the execution is terminated and no external effect occurs.

FIG. 1 illustrates that execution authority originates solely from Kernel admission and does not arise from inference, policy evaluation, model reasoning, optimization scoring, or human approval.

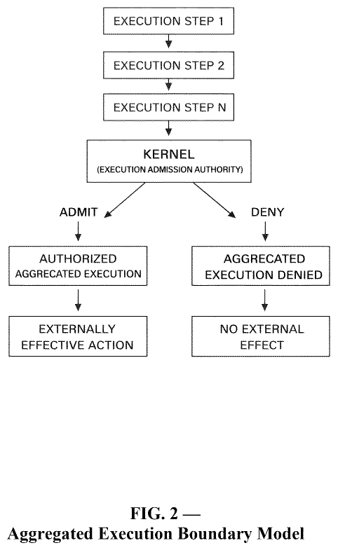

FIG. 2—A ggregated Execution Boundary Model

Referring to FIG. 2, multiple execution steps (Execution Step 1 through Execution Step N) are aggregated into a single execution bundle prior to Kernel evaluation.

The aggregated execution is transmitted to the Kernel as a single indivisible action request. The Kernel admits or denies the aggregated execution in its entirety.

If admitted, the aggregated execution proceeds as an authorized aggregated execution producing an externally effective action. If denied, the aggregated execution is denied in full and no externally effective action occurs.

FIG. 2 illustrates that execution authority applies at the boundary of effect and cannot be circumvented by distributing control logic across multiple intermediate steps.

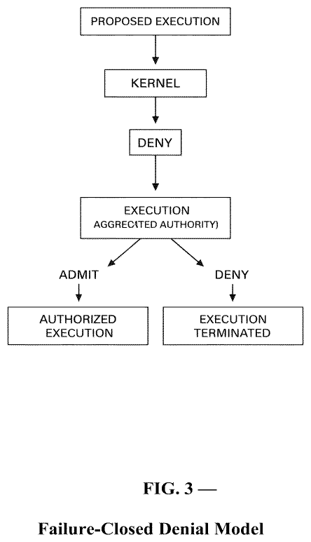

FIG. 3—Failure-Closed Denial Model

Referring to FIG. 3, a proposed execution is submitted to the Kernel. In the absence of Kernel admission, the system defaults to denial.

Execution denial results in termination prior to any externally effective action. No external effect occurs without contemporaneous Kernel admission.

FIG. 3 illustrates failure-closed operation in which the absence of admission is sufficient to prevent execution, and no substitute mechanism may confer execution authority.

### Definitions And Interpretive Framework

For purposes of this disclosure, the following terms shall have the meanings set forth below.

Kernel means a logically superior execution-admission authority distinct from artificial intelligence components.

Execution means any operation capable of producing an externally effective action.

Externally Effective Action means any action causing effect outside internal computation.

Execution Authority means lawful permission for execution to occur.

Admission means Kernel authorization granted prior to effect.

Pre-Effect means temporally and causally prior to any externally effective action.

Non-Delegable means incapable of delegation, inference, reconstruction, or substitution.

Artificial Intelligence Component includes models, agents, workflows, tools, or subsystems.

These definitions are functional and non-limiting.

### Architectural Relationship

The Kernel is logically superior to all artificial intelligence components. The Kernel may be implemented in centralized, distributed, hardware, software, firmware, or hybrid forms without limitation.

### Authority Model

Execution authority exists solely upon Kernel admission prior to effect. Execution authority does not arise from correctness, safety scoring, ethical analysis, explainability, regulatory approval, economic incentives, optimization objectives, or human approval.

### Pre-Effect Enforcement Principle

Kernel admission must occur prior to any externally effective action. Monitoring, auditing, rollback, remediation, or explanation occurring after effect does not constitute execution authority.

### Failure-Closed Operation

In the absence of Kernel admission, execution is denied by default.

### Applicability Across Domains

The invention applies to software agents, robotics, financial systems, infrastructure automation, cyber-physical systems, multi-tenant platforms, and distributed artificial intelligence environments.

### Non-Design-Around Statement

Execution authority cannot be substituted by omission of the Kernel, relocation of control logic, abstraction of decision layers, aggregation of steps, consensus mechanisms, or post-hoc validation.

1. A computer-implemented artificial intelligence execution control system, comprising:
a Kernel distinct from artificial intelligence components and operating as a mandatory execution-admission authority;
one or more artificial intelligence components configured to generate proposed execution requests; and
an execution boundary enforced by the Kernel, wherein execution capable of producing an externally effective action is permitted to occur only upon admission by the Kernel prior to effect;
wherein the Kernel is configured to perform execution admission by selectively enabling or preventing propagation of the proposed execution request;
wherein execution authority exists solely upon Kernel admission at the execution boundary;
wherein externally effective action is structurally impossible unless the proposed execution request is admitted by the Kernel prior to effect; and
wherein, in the absence of Kernel admission, the proposed execution request is prevented from propagating such that no externally effective action can occur.

2. The system of claim 1, wherein execution authority is non-delegable such that no artificial intelligence component, agent, workflow, model, policy engine, or external system may grant execution authority independently of the Kernel.

3. The system of claim 1, wherein Kernel admission occurs temporally and causally prior to any externally effective action, and wherein post-effect monitoring, auditing, rollback, remediation, or explanation does not constitute execution authority.

4. The system of claim 1, wherein multiple execution steps are evaluated as an aggregated execution boundary and admitted or denied as a single indivisible execution.

5. The system of claim 1, wherein execution authority cannot arise through relocation of control logic, abstraction of decision layers, consensus mechanisms, distributed policies, or post-hoc validation.

6. A computer-implemented method for governing execution in an artificial intelligence system, comprising:
receiving a proposed execution request from an artificial intelligence component;
evaluating the proposed execution request at a Kernel operating as a mandatory execution-admission authority; and
permitting execution only upon Kernel admission prior to effect; and preventing propagation of the proposed execution request in the absence of Kernel admission such that no externally effective action can occur.

7. A non-transitory computer-readable medium storing instructions that, when executed by one or more processors, cause the processors to perform the method of claim 6.
